(19) United States
(12) Patent Application Publication
(10) Pub. No.: US 2010/0048267 A1
(43) Pub. Date: Feb. 25, 2010

(54) Disposable protector case for cell phone with touchable lens to be used with a touchscreen cell phone

(75) Inventor: Alan Nathan Lin, Arcadia, CA (US)

Correspondence Address: ROZSA LAW GROUP LC, 18757 BURBANK BOULEVARD, SUITE 220, TARZANA, CA, 91356-3346, US

(73) Assignees: BEYOND ELECTRONICS INC.; DBA BEYOND CELL

(21) Appl. No.: 12/387,162

(22) Filed: Apr. 29, 2009

(30) Foreign Application Priority Data
Aug. 19, 2008 (CN) 200820188858.5

(51) Int. Cl. H04M 1/00

(52) U.S. Cl. 455/575.8

(57) ABSTRACT

The present invention is designed to provide the ability to protect the LCD screen of a touchscreen cell phone from being scratched by incorporating into a protector case for the touchscreen LCD a thin transparent lens so that an individual's fingers or a stylus do not directly come in contact with the touchscreen of the LCD phone but instead, are shielded by the lens so that in the event that there are scratches on the lens, the case can be easily discarded and replaced with another inexpensive case which contains the protector case to protect the cell phone and the lens to protect the touchscreen LCD.

### BACKGROUND OF THE INVENTION

1. Field of the Invention

The present invention relates to the field of protector cases for a cell phone which are used with cell phones that have a touchscreen for manual inputting data such as telephone numbers.

In everyday life, the situation has existed where a cell phone is dropped and a screen is scratched in some way. Therefore, a protector case for the cell phone was invented. In the present market of cell phone accessories, the protector cases for bar phones or flip phones, as well as for cell phones with touchscreens always have the opening area at the LCD screen area. Therefore, the portions of the cell phone which are protected are the four corners of the cell phone case itself, but the touchscreen is not protected. Cell phones with a touchscreen LCD have the touchscreen exposed so that fingerprints can appear on the LCD screen and a fingernail may accidentally scratch the LCD screen. It is therefore desirable to have a means to protect the touchscreen of a cell phone while at the same time enabling an individual to manually input the information on the touchscreen.

2. Description of the Prior Art

The following patents are in existence that disclose touchscreens that have cell phone protector cases for touchscreens:

1. U.S. Pat. No. 6,646,864 issued on Nov. 11, 2003 to Richardson for “Protective Case for Touch Screen Device”.

2. U.S. Pat. No. 6,995,976 issued on Feb. 7, 2006 to Richardson for “Protective Membrane for Touchscreen Device”.

3. U.S. Pat. No. 6,273,252 issued to Burke H. Mitchell on Aug. 14, 2001 for “Protective Covering For A Hand-Held Device” (hereafter the “Mitchell Patent”).

4. United States Published Patent Application No. 2006/0274493 to Curtis R. Richardson et al. on Dec. 7, 2006 for “Protective Enclosure For Electronic Device” (hereafter the “Richardson Published Patent Application”).

5. U.S. Pat. No. 7,180,735 issued to Brian P. Thomas et al. and assigned to Otter Products, LLC on Feb. 20, 2007 for “Protective Enclosure And Watertight Adapter For An Interface Flat-Panel Controlled Device” (hereafter the “Thomas Patent”).

6. U.S. Pat. No. 7,230,823 issued to Curtis B. Richardson et al. and assigned to Otter Products, LLC on Jun. 12, 2007 for “Protective Membrane For Touch Screen Device” (hereafter the “'823 Richardson Patent”).

7. U.S. Pat. No. 7,312,984 issued to Curtis B. Richardson et al. and assigned to Otter Products, LLC on Dec. 25, 2007 for “Protective Enclosure And Watertight Adapter For An Interactive Flat-Panel Controlled Device” (hereafter the “'984 Richardson Patent”).

8. United States Published Patent Application No. 2008/0055258 to Matthew Carlyle Saucers on Mar. 6, 2008 for “Enclosure To Prevent Fluid Ingress Of A Device Having A Touch Screen Interface” (hereafter the “Saucers Published Patent Application”).

9. International Application No. WO 03/001776 issued to Michael Hus et al. and assigned to Dow Global Technologies Inc. on Jan. 3, 2003 for “Protective Sealable Transparent Flexible Membrane For Electronic Touch Screens” (hereafter the “Hus International Application”).

While all of the above applications and issued patents disclose having a membrane which can be used as a touchscreen device, in each case, the device is a rather expensive and non-throwaway protector case wherein the membrane is replaceable, the membrane has a gasket, and the protector case is either crush resistant and/or waterproof. While these have beneficial effects, it has been found that it is an improvement to have a simple disposable case that provides the protection for the cell phone and enables manual inputting of data on a touchscreen for an LCD cell phone screen but at the same time in the event the membrane becomes scratched, then the entire case can be disposed of and replaced with an inexpensive case.

### SUMMARY OF THE INVENTION

The present invention is a disposable protector case for a cell phone which is made of inexpensive material and which can be simply discarded in the event the protector case is damaged or the lens which covers the touchscreen of an LCD screen of a cell phone is scratched or otherwise damaged.

The present invention is designed to provide the ability to protect the LCD screen of a touchscreen cell phone from being scratched by incorporating into a protector case for the touchscreen LCD a thin transparent lens so that an individual's fingers do not directly come in contact with the touchscreen of the LCD phone but instead, are shielded by the lens so that in the event that there are scratches on the lens, the case can be easily discarded and replaced with another inexpensive case which contains the protector case to protect the cell phone and the lens to protect the touchscreen LCD.

The protector case for the cell phone with a touchscreen LCD consists of the top and bottom parts of the case. The related top part of the case with the opening at the LCD screen location consists of a transparent protective lens.

Furthermore, the related transparent protective lens is made of composite plastic. The related transparent protective lens and the top part of the case form together as one piece. The protective transparent lens at the related opening of the top part of the case allows full access to the touch function of the screen of the cell phone. The placement of the transparent protective lens is set by a socket of the top part of the case. Alternatively, the transparent protective lens can be affixed to the outer frame of the top part of the case. The top part and the bottom part of the case are interlocked by at least two gripping clips to lock the cell phone in place. The shape, the size and the opening areas of the top and the bottom parts of the case are made to suit the size and shape of the cell phone.

In comparing the present invention with prior art cell phone protector cell phone cases that are known, the present invention has the following advantages:

1. The cell phone protector case has an open area which is aligned with the touchscreen of an LCD touchscreen cell phone and the cell phone protector case includes a transparent plastic protective lens in the open area so that a person's fingers or fingernails or a stylus will not come in direct contact with the touchscreen of the LCD screen and the protective lens helps to prevent scratches to the LCD screen of the cell phone, as well as preventing finger marks on the LCD screen. This enables an individual to prolong the life of a touchscreen cell phone.

2. The design of the present invention consists of the transparent touchable protective lens at the open area of the top part of the protector. In the event that the protective lens and/or case is scratched or damaged, the entire cell phone protector case can be easily discarded because it is made of inexpensive material and replaced with a substitute protector case with a new protective lens.

3. Unlike other prior art cell phone protector cases, the present invention does not have a replaceable lens and does not have a waterproof protector case and is not crush resistant. It is simply a protector case that is designed to protect the exterior of the cell phone and includes a transparent plastic protective lens at the location of the touchscreen of the LCD screen so that an individual's fingers or fingernails or a stylus do not come directly in contact with the touchscreen but instead, by pressing on the thin lens, the manual transmission is directly communicated to the touchscreen of the cell phone so that the cell phone can be operated in a touchscreen manner while having the LCD screen protected.

4. In addition, the transparent lens can have an extra chemical coating to create multiple covering layers so that in the event a user wishes to maintain his/her transmission confidential, the layers will prevent anybody who is not directly looking at the cell phone from seeing what is being inputted into the touchscreen or the LCD display.

Further novel features and other objects of the present invention will become apparent from the following detailed description, discussion and the appended claims, taken in conjunction with the drawings.

### BRIEF DESCRIPTION OF THE DRAWINGS

Referring particularly to the drawings for the purpose of illustration only and not limitation, there is illustrated:

FIG. 1 is a perspective view of the protector case of the present invention which includes a transparent touchable protective lens on the top part of the case; and

FIG. 2 is an exploded view which shows the components which are the bottom case, the top case and the transparent touchable protective lens which is affixed to the top part of the case or into a socket in the top part of the case.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention as further defined in the appended claims.

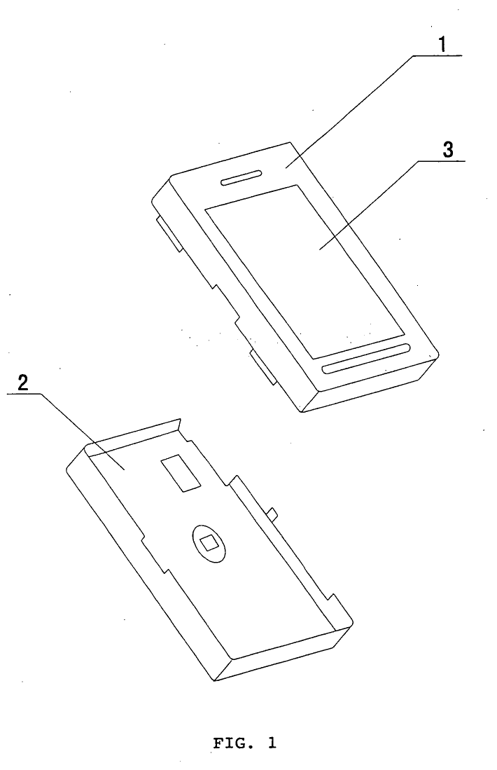

Referring to FIG. 1, the protector case for a touchscreen cell phone is divided into two parts, a top 1 and a bottom 2. In this embodiment, the transparent plastic protective lens 3 and the top part of the protector case 1 are formed together as one piece or the transparent plastic protective lens 3 is permanently affixed to an exterior surface of the top part 1 or into a socket on the exterior surface of the top part 1. Alternatively, the transparent plastic protective lens can be affixed to the interior of the top part of the case 1. The shape of the top part 1, the bottom part 2 and the transparent plastic protective lens 3 are made to fit different models of cell phones with a touchscreen LCD. The top part 1 and the bottom part 2 are interlocked by two or more gripping clips to hold the cell phone in place.

To install a cell phone in the case, the top part 1 is installed onto the front side of the cell phone. The bottom part 2 will rest over the rear side of the cell phone. The gripping clips are used to attach both parts of the case in place.

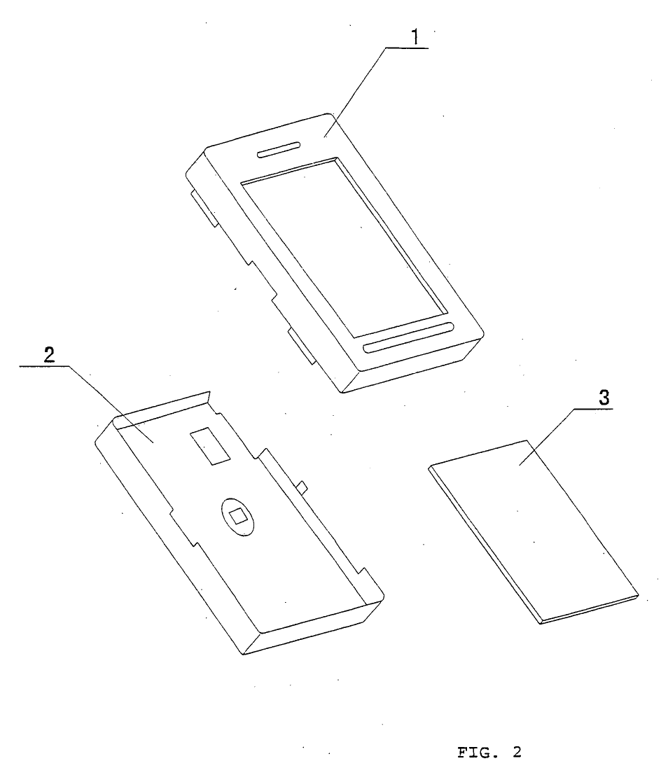

Referring to FIG. 2, the protector case for a touchscreen cell phone is divided into three parts, top 1, a bottom 2 and the touchable protective lens 3. For the top part 1 the opening for the touchscreen LCD is for the touchable plastic protective lens 3. The shapes of the top part 1, the bottom part 2 and the transparent touchable protective lens 3 are made to fit different models of cell phones with a touchscreen LCD. The top part 1 and the bottom part 2 are interlocked by at least 2 gripping clips to hold the cell phone in place.

The transparent plastic protective lens 3 is affixed onto an outer surface of the top part 1 of the case or to an interior surface of the top part of the case. The user places the top part 1 of the case onto the front side of the cell phone, and the transparent plastic protective lens 3 covers the opening area of the touchscreen and will provide protection to the screen 14 of the cell phone. The bottom part of the case 2 is then placed on the rear of the cell phone and then the top and bottom are locked together.

The benefit of the present invention is that it is made of simple inexpensive material. Therefore, rather than have the costly protector case as discussed in the prior art which includes crush resistance, waterproof features and replaceable lenses, as well as gaskets and other extensive expensive protector case features, the present invention is a simple disposable protector case which has a top and a bottom which cover the top and the bottom of the cell phone and has an opening to be aligned with the LCD screen of the cell phone with a touchable transparent plastic lens in the opening so that an individual can manually touch the lens with a finger, fingernail or stylus and manually transmit signals to the touchscreen of the cell phone so that the individual's fingers, fingernails or stylus will not come directly in contact with the LCD screen but will instead, provide a protection so that data can be manually inputted with a finger or stylus on the touchscreen but the touchscreen itself will not be scratched or damaged. In the event the lens 3 or the protector case top 1 or bottom 2 become scratched or damaged, the easily disposable case can be thrown away and replaced with an inexpensive replacement case.

In addition, another benefit of the present invention is that the touchable protective lens 3 has a multiplicity of coatings which would block being able to see what is being inputted in the touchscreen through the protective lens unless the person is looking directly at the cell phone. Therefore, if someone is seated next to the user and the user who is using the cell phone does not want the person seated next to him to see what is being inputted, then there will be a privacy function where the multiple layers of coatings on the protective lens prevent anyone from seeing what is being inputted into the touchscreen through the protective lens if the person is seated to the side of the user who is inputting the information.

Defined in detail, the present invention is a protector case for use in conjunction with a cell phone having a touchscreen comprising: (a) a top half having an opening therein and a mating bottom half, a cell phone being retained between the top half and the bottom half so that the touchscreen of the cell phone is aligned with the opening in the top half of the protector case; (b) a thin transparent protective lens affixed to an exterior of the top half of the protector case and aligned with the touchscreen of the cell phone so that when the cell phone is retained within the top and bottom portions of the protector case, manual input can be made to the touchscreen of the cell phone by touching the thin transparent lens so that information can be transmitted manually to the touchscreen; and (c) the protector case and thin transparent protective lens made of inexpensive material so that in the event the thin transparent protective lens and/or the protector case becomes damaged, the protector case can easily be discarded and replaced with an inexpensive new protector case.

Defined broadly, the present invention is protector case for use in conjunction with a cell phone having a touchscreen comprising:(a) a top half having an opening therein and a mating bottom half, a cell phone being retained between the top half and the bottom half so that the touchscreen of the cell phone is aligned with the opening in the top half of the protector case; (b) a touchable thin transparent protective lens affixed to the top half of the protector case and aligned with the touchscreen of the cell phone so that when the cell phone is retained within the top and bottom portions of the protector case, manual input can be made to the touchscreen of the cell phone by touching the touchable thin transparent lens so that information can be transmitted manually to the touchscreen; and (c) the protector case and touchable thin transparent protective lens made of inexpensive material so that in the event the touchable thin transparent protective lens and/or the protector case becomes damaged, the protector case can easily be discarded and replaced with an inexpensive new protector case.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A protector case for use in conjunction with a cell phone having a touchscreen comprising:
a. a top half having an opening therein and a mating bottom half, a cell phone being retained between the top half and the bottom half so that the touchscreen of the cell phone is aligned with the opening in the top half of the protector case;
b. a thin transparent protective lens affixed to an exterior of the top half of the protector case and aligned with the touchscreen of the cell phone so that when the cell phone is retained within the top and bottom portions of the protector case, manual input can be made to the touchscreen of the cell phone by touching the thin transparent lens so that information can be transmitted manually to the touchscreen; and
c. the protector case and thin transparent protective lens made of inexpensive material so that in the event the thin transparent protective lens and/or the protector case becomes damaged, the protector case can easily be discarded and replaced with an inexpensive new protector case.

2. The protector case in accordance with claim 1, wherein the thin transparent protective lens is made of thin transparent plastic.

3. The protector case in accordance with claim 1, wherein the thin transparent protective lens includes a multiplicity of film coatings so that information inputted through the protective lens onto the touchscreen of the LCD cannot be seen unless the person is looking directly at the cell phone as the information is being inputted.

4. A protector case for use in conjunction with a cell phone having a touchscreen comprising:
a. a top half having an opening therein and a mating bottom half, a cell phone being retained between the top half and the bottom half so that the touchscreen of the cell phone is aligned with the opening in the top half of the protector case;
b. a touchable thin transparent protective lens affixed to the top half of the protector case and aligned with the touchscreen of the cell phone so that when the cell phone is retained within the top and bottom portions of the protector case, manual input can be made to the touchscreen of the cell phone by touching the touchable thin transparent lens so that information can be transmitted manually to the touchscreen; and
c. the protector case and touchable thin transparent protective lens made of inexpensive material so that in the event the touchable thin transparent protective lens and/or the protector case becomes damaged, the protector case can easily be discarded and replaced with an inexpensive new protector case.

5. The protector case in accordance with claim 4, wherein the touchable thin transparent protective lens is made of thin transparent plastic.

6. The protector case in accordance with claim 4, wherein the thin transparent protective lens includes a multiplicity of film coating so that information inputted through the protective lens onto the touchscreen of the LCD cannot be seen unless the person is looking directly at the cell phone as the information is being inputted.
